(19) United States
(12) Patent Application Publication
(10) Pub. No.: US 2023/0331947 A1
(43) Pub. Date: Oct. 19, 2023

(54) ADDITIVE COMPOSITION AND METHOD FOR USING THE SAME

(71) Applicant: Milliken & Company, Spartanburg, SC (US)

(72) Inventors: Mark Ragsdale, Duncan, SC (US); Sharon Free, Chesnee, SC (US); Chunping Xie, Shanghai (CN); Sanjeev Dey, Spartanburg, SC (US)

(21) Appl. No.: 18/135,261

(22) Filed: Apr. 17, 2023

Related U.S. Application Data
(60) Provisional application No. 63/331,953, filed on Apr. 18, 2022.

(51) Int. Cl. C08J 9/00; B01J 20/18; C08G 18/48; C08G 18/10

(52) U.S. Cl. CPC C08J 9/0066; B01J 20/18; C08G 18/48; C08G 18/10; C08J 2375/08

(57) ABSTRACT

An additive composition comprises a polyol and a zeolite composite. The zeolite composite comprises a zeolite substrate and a nitrogen-containing compound adsorbed within at least a portion of the pores in the surface of the zeolite substrate. The nitrogen-containing compound comprises (A) a first functional group comprising a carbon atom doubly bonded to a nitrogen atom and (B) a second functional group comprising a hydrogen atom covalently bonded to a nitrogen atom. A method for making a polyurethane polymer comprises the steps of providing a first polyol, providing an isocyanate compound, providing an additive composition as described above, combining the first polyol, the isocyanate compound, and the additive composition to produce a reaction mixture, and reacting the isocyanate compound with the first and second polyols to produce a polyurethane polymer.

### CROSS-REFERENCE TO RELATED PATENT APPLICATIONS

This application claims, pursuant to 35 U.S.C. § 119(e), priority to and the benefit of the filing date of U.S. Patent Application No. 63/331,953, which was filed on Apr. 18, 2022, the contents of which are hereby incorporated by reference

### TECHNICAL FIELD OF THE INVENTION

The present application is directed to additive compositions for reducing volatile organic emissions (e.g., aldehyde emissions) from polymeric materials, such as polyurethane polymers and foams. The present application is also directed to methods for making polyurethane polymers and foams using such additive compositions.

### BACKGROUND

Polyurethane polymers are used in a wide variety of applications, such as the production of polyurethane foams. These polyurethane foams are, in turn, put to many different end uses. For example, polyurethane foams are frequently used as cushioning and padding in, for example, transportation seating (e.g., automobile seating) and furniture, such as mattresses and other cushioned furniture. When these polyurethane foams are used in enclosed environments, such as the interior of an automobile or other vehicle, the foam typically must pass tests that limit the amount of volatile organic compounds that can be released by the foam. The volatile organic compounds emitted by the polyurethane foam during testing can be produced as a by-product of the reaction that produces the polyurethane polymer. The volatile organic compounds (e.g., aldehydes such as formaldehyde, acetaldehyde, and propionaldehyde) can also be present in the raw materials used to make the foam (e.g., the polyol). These volatile organic compounds can impart undesirable, foul odors to the raw materials and to the polyurethane polymers/foams made with those raw materials. Therefore, it would be desirable to find a composition or method that reduces the detectable levels of volatile organic compounds present in the polyurethane polymers/foams. This application seeks to provide such a composition and method.

### BRIEF SUMMARY OF THE INVENTION

In a first embodiment, the invention provides an additive composition comprising a polyol and a zeolite composite. Preferably, the additive composition comprises:
(a) a polyol;
(b) a zeolite composite dispersed in the polyol, the zeolite composite comprising:
   (i) a zeolite substrate, said zeolite substrate having a surface and a plurality of pores in said surface; and
   (ii) a nitrogen-containing compound adsorbed within at least a portion of the pores in the surface of the zeolite substrate, the nitrogen-containing compound comprising (A) a first functional group comprising a carbon atom doubly bonded to a nitrogen atom and (B) a second functional group comprising a hydrogen atom covalently bonded to a nitrogen atom.

In a second embodiment, the invention provides a method for making a polyurethane polymer (e.g., a polyurethane foam) using the additive composition of the first embodiment. Preferably, the method comprises the steps of:
(a) providing a first polyol;
(b) providing an isocyanate compound comprising two or more isocyanate groups;
(c) providing an additive composition comprising:
   (i) a second polyol; and
   (ii) a zeolite composite dispersed in the second polyol, the zeolite composite comprising:
      (A) a zeolite substrate, said zeolite substrate having a surface and a plurality of pores in said surface; and
      (B) a nitrogen-containing compound adsorbed within at least a portion of the pores in the surface of the zeolite substrate, the nitrogen-containing compound comprising (1) a first functional group comprising a carbon atom doubly bonded to a nitrogen atom and (2) a second functional group comprising a hydrogen atom covalently bonded to a nitrogen atom;
(d) combining the first polyol, the isocyanate compound, and the additive composition to produce a reaction mixture; and
(e) reacting the isocyanate compound with the first and second polyols to produce a polyurethane polymer, wherein the zeolite composite is dispersed in the polyurethane polymer.

### DETAILED DESCRIPTION OF THE INVENTION

In a first embodiment, the invention provides an additive composition comprising a polyol and a zeolite composite dispersed in the polyol. The zeolite composite comprises a zeolite substrate and a nitrogen-containing compound adsorbed within at least a portion of the pores in the surface of the zeolite substrate.

The additive composition can comprise any suitable polyol. Suitable polyols include polyether polyols and polyester polyols. Suitable polyether polyols include those made by reacting epoxides, such as ethylene oxide, propylene oxide, butylene oxide, and glycidol, with a multifunctional initiator compound, such as a multifunctional alcohol or amine. Examples of suitable multifunctional initiator compounds include, but are not limited to, water, glycerin, pentaerythritol, ethylene glycol, propylene glycol (e.g., 1,2-propylene glycol), trimethylolpropane, and ethylenediamine. Suitable polyester polyols include those made by reacting a polycarboxylic acid or anhydride with a multifunctional alcohol, such as glycerin, pentaerythritol, ethylene glycol, diethylene glycol, propylene glycol (e.g., 1,2-propylene glycol), and trimethylolpropane. Examples of suitable polycarboxylic acids and anhydrides include, but are not limited to, adipic acid, maleic acid, maleic anhydride, succinic acid, succinic anhydride, azelaic acid, glutaric acid, phthalic acid, and phthalic anhydride. Preferably, the polyol is a polyether polyol.

The polyol can have any suitable molar mass. In a preferred embodiment, the polyol has a molar mass of about 400 g/mol or more. More preferably, the polyol has a molar mass of about 500 g/mol or more, about 750 g/mol or more, or about 1,000 g/mol or more. Preferably, the polyol has a molar mass of about 20,000 g/mol or less, more preferably about 15,000 g/mol or less or about 10,000 g/mol or less. Thus in a series of preferred embodiments, the polyol has a molar mass of about 400 g/mol to about 20,000 g/mol (e.g., about 400 g/mol to about 15,000 g/mol or about 400 g/mol to about 10,000 g/mol), about 500 g/mol to about 20,000 g/mol (e.g., about 500 g/mol to about 15,000 g/mol or about 500 g/mol to about 10,000 g/mol), about 750 g/mol to about 20,000 g/mol (e.g., about 750 g/mol to about 15,000 g/mol or about 750 g/mol to about 10,000 g/mol), or about 1,000 to about 20,000 g/mol (e.g., about 1,000 g/mol to about 15,000 g/mol or about 1,000 g/mol to about 10,000 g/mol).

As noted above, the additive composition comprises a zeolite composite, which zeolite composite comprises a zeolite substrate and a nitrogen-containing compound. The zeolite substrate can comprise any suitable zeolite. Zeolites are aluminosilicate minerals that can contain a wide variety of cations, such as H⁺, Na⁺, Ca²⁺, Mg²⁺, and others. Zeolites are a member of the family of microporous solids known as “molecular sieves,” which is a group of materials that can selectively sort molecules primarily based on a size exclusion process. This sorting ability is due to a very regular pore structure in the zeolite that is of molecular dimensions. The maximum size of the molecular or ionic species that can enter the pores of the zeolite is dictated by the dimensions of the zeolite's channels, which are defined by the ring size of the tetrahedrally coordinated silicon/aluminum and oxygen atoms from which the zeolite is made. The zeolite substrate can comprise any naturally-occurring or synthetic zeolite, with synthetic zeolites being preferred due to their lack of contamination by other minerals, etc. In a preferred embodiment, the zeolite is an H⁺ cation zeolite (i.e., a zeolite in which at least a portion of the countercations in the aluminosilicate mineral are H⁺ cations).

As noted above, the zeolite has a microporous structure, and the pores making up this microporous structure can be any suitable size. Preferably, the pore size of the zeolite is about 0.1 nm or greater, more preferably about 0.2 nm or greater or 0.3 nm or greater. The pore size of the zeolite generally does not exceed about 1 nm, and preferably is about 0.9 nm or less. Thus, in a series of preferred embodiments, the pore size of the zeolite is about 0.1 nm to about 1 nm (e.g., about 0.1 nm to about 0.9 nm), about 0.2 nm to about 1 nm (e.g., about 0.2 nm to about 0.9 nm), or about 0.3 nm to about 1 nm (e.g., about 0.3 nm to about 0.9 nm).

The microporous structure of the zeolite can also (or alternatively) be characterized using the BET specific surface area. Zeolites suitable for use in making the zeolite composite preferably have a BET specific surface area of about 100 m²/g or more, about 150 m²/g or more, or about 200 m²/g or more. The zeolites preferably have a BET specific surface area of about 1,000 m²/g or less, about 900 m²/g or less, or about 800 m²/g or less. Thus, in a series of preferred embodiments, the zeolite used in making the zeolite composite has a BET specific surface of about 100 m²/to about 1,000 m²/g (e.g., about 100 m²/g to about 900 m²/g or about 100 m²/g to about 800 m²/g), about 150 m²/g to about 1,000 m²/g (e.g., about 150 m²/g to about 900 m²/g or about 150 m²/g to about 800 m²/g), or about 200 m²/g to about (e.g., about 200 m²/g to about 900 m²/g or about 200 m²/g to about 800 m²/g).

The zeolites used in making the zeolite composite can have any suitable particle size. Suitable zeolites preferably have a particle of about 2 μm or more. Suitable zeolites preferably have a particle size of about 10 μm or more. Thus, the zeolite preferably has a particle size of about 2 μm to about 10 μm.

The zeolite composite comprises a nitrogen-containing compound. The nitrogen-containing compound preferably is adsorbed within at least a portion of the pores in the surface of the zeolite substrate. The nitrogen-containing compound can be any suitable organic compound comprising nitrogen atoms. Preferably, the nitrogen-containing compound comprises a first functional group comprising a carbon atom doubly bonded to a nitrogen atom (i.e., an imine group). More preferably, the nitrogen-containing compound comprises (A) a first functional group comprising a carbon atom doubly bonded to a nitrogen atom (i.e., an imine group) and (B) a second functional group comprising a hydrogen atom covalently bonded to a nitrogen atom (e.g., a primary amine group or a secondary amine group). In a preferred embodiment, the nitrogen-containing compound comprises at least two second functional groups comprising a hydrogen atom covalently bonded to a nitrogen atom (i.e., the nitrogen-containing compound comprises two or more primary amine groups or secondary amine groups). Preferred nitrogen-containing compounds include any compound possessing the attributes described above. Suitable examples of such preferred nitrogen-containing compounds include, but are not limited to, guanidine compounds, aminoguanidine compounds, biguanide compounds, guanamine compounds, and mixtures thereof. Suitable guanidine compounds include, but are not limited to, guanidine itself and salts thereof, such as guanidine hydrochloride, guanidine carbonate, guanidine nitrate, guanidine sulfate, and mixtures of the foregoing. Suitable aminoguanidine compounds include, but are not limited to, aminoguanidine itself and salts thereof, such as aminoguanidine sulfate, aminoguanidine hydrochloride, aminoguanidine nitrate, diaminoguanidine hydrochloride, diaminoguanidine sulfate, triaminoguanidine hydrochloride, and mixtures of the foregoing. Suitable biguanide compounds include, but are not limited to, biguanide and its salts, metformin and its salts (e.g., metformin hydrochloride), buformin and its salts (e.g., buformin hydrochloride), phenformin and its salts (e.g., phenformin hydrochloride), and mixtures of the foregoing. Suitable guanamine compounds include, but are not limited to, benzoguanamine and its salts, acetoguanamine and its salts, adipoguanamine (i.e., 6,6′-(1,4-butanediyl)bis-1,3,5-triazine-2,4-diamine) and its salts, 2-methylglutaroguanamine (i.e., 6,6′-(2-methyl-1,3-propanediyl)bis-1,3,5-triazine-2,4-diamine) and its salts, isoadipoguanamine and its salts, 6,6′-(1-ethyl-1,2-ethanediyl)bis-1,3,5-triazine-2,4-diamine and its salts, 6,6′-(1-methyl-1,3-propanediyl)bis-1,3,5-triazine-2,4-diamine and its salts, and mixtures of the foregoing. In a preferred embodiment, the nitrogen-containing compound is selected from the group consisting of aminoguanidine compounds, biguanide compounds, guanamine compounds, and mixtures thereof. Preferably, the nitrogen-containing compound is soluble in water, meaning it exhibits a solubility in water of 500 g/L or greater. In another preferred embodiment, the nitrogen-containing compound is an aminoguanidine compound, more preferably a waters-soluble aminoguanidine compound selected from the group consisting of aminoguanidine sulfate, aminoguanidine hydrochloride, aminoguanidine nitrate, diaminoguanidine hydrochloride, diaminoguanidine sulfate, triaminoguanidine hydrochloride, and mixtures of the foregoing.

The zeolite composite can contain any suitable amount of the nitrogen-containing compound. Preferably, the nitrogen-containing compound is present in the zeolite composite in an amount of about 5 wt. % or more, based on the combined weight of the zeolite substrate and the nitrogen-containing compound. More preferably, the nitrogen-containing compound is present in the zeolite composite in an amount of about 10 wt. % or more, about 15 wt. % or more, or about 20 wt. % or more, based on the combined weight of the zeolite substrate and the nitrogen-containing compound. There does not appear to be any upper limit to the amount of nitrogen-containing compound that can be present in the zeolite composite. Rather, the maximum amount of nitrogen-containing compound appears to be dependent upon the structure of the zeolite substrate and its ability to adsorb the nitrogen-containing compound. That being said, it is believed that increasing amounts of nitrogen-containing compound provide diminished returns when the mass of the added nitrogen-containing compound is equal to or exceeds the mass of the zeolite substrate. Thus, in a preferred embodiment, the nitrogen-containing compound is present in the zeolite composite in an amount of about 50 wt. % or less, based on the combined weight of the zeolite substrate and the nitrogen-containing compound. In a series of preferred embodiments, the nitrogen-containing compound is present in the zeolite composite in an amount of about 5 wt. % to 50 wt. %, about 10 wt. % to about 50 wt. %, about 15 wt. % to about 50 wt. %, or about 20 wt. % to about 50 wt. %, based on the combined weight of the zeolite substrate and the nitrogen-containing compound.

The zeolite composite can be made by any suitable method. Preferably, the zeolite composite is made by dissolving the desired quantity of the nitrogen-containing compound in an appropriate solvent (e.g., water). The zeolite substrate is then added to the resulting solution of the nitrogen-containing compound, and the resulting slurry is mixed/agitated. While the slurry is agitated, the zeolite substrate is thoroughly wetted with the solution, which results in the nitrogen-containing compound being adsorbed within at least a portion of the pores of the zeolite substrate. The wetted zeolite substrate is then dried to remove residual solvent and yield the above-described zeolite composite. The wetted zeolite substrate can be dried using any suitable method, such as heating the wetted zeolite substrate to an elevated temperature (e.g., when the solvent is water, heated to a temperature of about 120° C. for approximately 8 hours). The wetted zeolite preferably is dried so that the residual solvent content (e.g., moisture content when water is used as the solvent) is less than 2 wt. %. The resulting zeolite composite can be used as is, or the zeolite composite can be ground or milled to reduce the particle size of any agglomerates that may have formed during the production process.

The zeolite composite can be present in the additive composition in any suitable amount. Preferably, the zeolite composite is present in the additive composition in an amount of about 1 wt. % or more, based on the combined weight of polyol and zeolite composite present in the additive composition. More preferably, the zeolite composite is present in the additive composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the combined weight of polyol and zeolite composite present in the additive composition. Preferably, the zeolite composite is present in the additive composition in an amount of about 50 wt. % or less, based on the combined weight of polyol and zeolite composite present in the additive composition. More preferably, the zeolite composite is present in the additive composition in an amount of about 45 wt. % or less, about 40 wt. % or less, about 35 wt. % or less, about 30 wt. % or less, or about 25 wt. % or less, based on the combined weight of polyol and zeolite composite present in the additive composition. Thus, in a series of preferred embodiments, the zeolite composite is present in the additive composition in an amount of about 1 wt. % to about 50 wt. % (e.g., about 1 wt. % to about 45 wt. %, about 1 wt. % to about 40 wt. %, about 1 wt. % to about 35 wt. %, about 1 wt. % to about 30 wt. %, or about 1 wt. % to about 25 wt. %), about 2 wt. % to about 50 wt. % (e.g., about 2 wt. % to about 45 wt. %, about 2 wt. % to about 40 wt. %, about 2 wt. % to about 35 wt. %, about 2 wt. % to about 30 wt. %, or about 2 wt. % to about 25 wt. %), about 3 wt. % to about 50 wt. % (e.g., about 3 wt. % to about 45 wt. %, about 3 wt. % to about 40 wt. %, about 3 wt. % to about 35 wt. %, about 3 wt. % to about 30 wt. %, or about 3 wt. % to about 25 wt. %), about 4 wt. % to about 50 wt. % (e.g., about 4 wt. % to about 45 wt. %, about 4 wt. % to about 40 wt. %, about 4 wt. % to about 35 wt. %, about 4 wt. % to about 30 wt. %, or about 4 wt. % to about 25 wt. %), about 5 wt. % to about 50 wt. % (e.g., about 5 wt. % to about 45 wt. %, about 5 wt. % to about 40 wt. %, about 5 wt. % to about 35 wt. %, about 5 wt. % to about 30 wt. %, or about 5 wt. % to about 25 wt. %), about 6 wt. % to about 50 wt. % (e.g., about 6 wt. % to about 45 wt. %, about 6 wt. % to about 40 wt. %, about 6 wt. % to about 35 wt. %, about 6 wt. % to about 30 wt. %, or about 6 wt. % to about 25 wt. %), about 7 wt. % to about 50 wt. % (e.g., about 7 wt. % to about 45 wt. %, about 7 wt. % to about 40 wt. %, about 7 wt. % to about 35 wt. %, about 7 wt. % to about 30 wt. %, or about 7 wt. % to about 25 wt. %), about 8 wt. % to about 50 wt. % (e.g., about 8 wt. % to about 45 wt. %, about 8 wt. % to about 40 wt. %, about 8 wt. % to about 35 wt. %, about 8 wt. % to about 30 wt. %, or about 8 wt. % to about 25 wt. %), about 9 wt. % to about 50 wt. % (e.g., about 9 wt. % to about 45 wt. %, about 9 wt. % to about 40 wt. %, about 9 wt. % to about 35 wt. %, about 9 wt. % to about 30 wt. %, or about 9 wt. % to about 25 wt. %), or about 10 wt. % to about 50 wt. % (e.g., about 10 wt. % to about 45 wt. %, about 10 wt. % to about 40 wt. %, about 10 wt. % to about 35 wt. %, about 10 wt. % to about 30 wt. %, or about 10 wt. % to about 25 wt. %), based on the combined weight of polyol and zeolite composite present in the additive composition. In one preferred embodiment, the zeolite composite is present in the additive composition in an amount of about 5 wt. % to about 30 wt. % (e.g., about 10 wt. % to about 30 wt. %, about 10 wt. % to about 25 wt. %, about 15 wt. % to about 30 wt. %, or about 15 wt. % to about 25 wt. %), based on the combined weight of polyol and zeolite composite present in the additive composition.

The additive composition can comprise other components in addition to the polyol and the zeolite composite. Suitable additional components for the additive composition include, but are not limited to, antioxidants, dispersing agents (e.g., surfactants such as polydimethylsiloxane-polyoxyalkylene block copolymers, silicone oils, and alcohol ethoxylates [e.g., nonylphenol ethoxylates]), aldehyde scavengers, and mixtures thereof. In a preferred embodiment, the additive composition comprises a dispersing agent, such as those listed above.

As noted above, many polyurethane foams have been observed to emit various volatile organic compounds, such as aldehyde compounds and amine compounds. These volatile organic compounds can have pungent odors, and prolonged exposure to such compounds can have adverse health effects. These odors and exposure hazards typically are exacerbated when the foams are placed in an enclosed space, such as the interior of a vehicle. In such enclosed spaces, the volatile organic compounds (e.g., aldehyde compounds and amine compounds) emitted by the polyurethane foam can quickly accumulate and rise to concentrations that are unpleasant or pose health hazards to vehicle occupants. When used as an additive in the manufacture of a polyurethane foam, the inventive additive composition has been shown to dramatically lower the amount of aldehyde compounds and amine compounds emitted by the polyurethane foam. As shown in the following examples, experimental observations have shown that the inventive additive composition lowers levels of, for example, formaldehyde, acetaldehyde, and triethylenediamine emitted by the foam. The observed reduction in the emissions of these compounds was significantly lower than the emissions observed from simple addition of the zeolite substrate and nitrogen-containing compound. The results demonstrate that the described zeolite composite (where the nitrogen-containing compound is absorbed into the pores of the zeolite) exhibits synergistic effects that extend beyond the effects attributable to the components themselves.

Thus, in a second embodiment, the invention provides a method for making a polyurethane polymer (e.g., a polyurethane foam) using the additive composition of the first embodiment. The method generally entails combining the additive composition with an appropriate polyol and isocyanate compound and reacting the resultant mixture to produce a polyurethane polymer. When an appropriate blowing agent is included in the reaction mixture, the polyurethane polymer is blown to produce a polyurethane foam.

Preferably, the method comprises the steps of: (a) providing a first polyol; (b) providing an isocyanate compound comprising two or more isocyanate groups; (c) providing an additive composition; (d) combining the first polyol, the isocyanate compound, and the additive composition to produce a reaction mixture; and (e) reacting the isocyanate compound with the first and second polyols to produce a polyurethane polymer, wherein the zeolite composite is dispersed in the polyurethane polymer. As noted above, the additive composition utilized in the method is an additive composition as described above. Thus, the additive composition comprises: (i) a second polyol; and (ii) a zeolite composite dispersed in the second polyol. The zeolite composite comprises: (A) a zeolite substrate having a surface and a plurality of pores in said surface; and (B) a nitrogen-containing compound adsorbed within at least a portion of the pores in the surface of the zeolite substrate. The nitrogen-containing compound preferably comprises (1) a first functional group comprising a carbon atom doubly bonded to a nitrogen atom and (2) a second functional group comprising a hydrogen atom covalently bonded to a nitrogen atom

The first polyol used in the method can be any suitable polyol or mixture of polyols. Suitable polyols for use in the method include polyether polyols and polyester polyols. Suitable polyether polyols include those made by reacting epoxides, such as ethylene oxide, propylene oxide, butylene oxide, and glycidol, with a multifunctional initiator compound, such as a multifunctional alcohol or amine. Examples of suitable multifunctional initiator compounds include, but are not limited to, water, glycerin, pentaerythritol, ethylene glycol, propylene glycol (e.g., 1,2-propylene glycol), trimethylolpropane, and ethylenediamine. Suitable polyester polyols include those made by reacting a polycarboxylic acid or anhydride with a multifunctional alcohol, such as glycerin, pentaerythritol, ethylene glycol, diethylene glycol, propylene glycol (e.g., 1,2-propylene glycol), and trimethylolpropane. Examples of suitable polycarboxylic acids and anhydrides include, but are not limited to, adipic acid, maleic acid, maleic anhydride, succinic acid, succinic anhydride, azelaic acid, azelaic anhydride, glutaric acid, glutaric anhydride, phthalic acid, and phthalic anhydride. The polyol or mixture of polyols used in the production of the polyurethane polymer will depend, at least in part, on the desired properties of the final polyurethane polymer. Preferably, the first polyol is a polyether polyol.

The first polyol used in the method can have any suitable molar mass. In a preferred embodiment, the first polyol has a molar mass of about 400 g/mol or more. More preferably, the first polyol has a molar mass of about 500 g/mol or more, about 750 g/mol or more, or about 1,000 g/mol or more. Preferably, the first polyol has a molar mass of about 20,000 g/mol or less, more preferably about 15,000 g/mol or less or about 10,000 g/mol or less. Thus in a series of preferred embodiments, the first polyol has a molar mass of about 400 g/mol to about 20,000 g/mol (e.g., about 400 g/mol to about 15,000 g/mol or about 400 g/mol to about 10,000 g/mol), about 500 g/mol to about 20,000 g/mol (e.g., about 500 g/mol to about 15,000 g/mol or about 500 g/mol to about 10,000 g/mol), about 750 g/mol to about 20,000 g/mol (e.g., about 750 g/mol to about 15,000 g/mol or about 750 g/mol to about 10,000 g/mol), or about 1,000 to about 20,000 g/mol (e.g., about 1,000 g/mol to about 15,000 g/mol or about 1,000 g/mol to about 10,000 g/mol).

The isocyanate compound used in the method can be any suitable isocyanate compound comprising two or more isocyanate groups. Suitable isocyanate compounds include, but are not limited to, aliphatic diisocyanates (e.g., hexamethylene diisocyanate, methylene dicyclohexyl diisocyanate, and isophorone diisocyanate), aromatic diisocyanates (e.g., toluene diisocyanate and methylene diphenyl diisocyanate), and mixtures thereof. Preferably, the isocyanate compound is an aromatic diisocyanate, such as toluene diisocyanate, methylene diphenyl diisocyanate, or a mixture thereof.

The additive composition utilized in the method can be any embodiment of the additive composition described above. In particular, the additive composition can comprise any suitable combination of the polyols, zeolite substrates, and nitrogen-containing compounds described above in connection with the additive composition.

The additive composition can be combined with the first polyol and isocyanate compound in any suitable amount. The amount of additive composition added typically is selected to provide a desired amount of the zeolite composite in the resulting reaction mixture (i.e., the combination of the first polyol, isocyanate compound, additive composition, and any other components). The amount of zeolite composite present preferably is expressed as a number of parts by weight of the zeolite composite per one hundred parts by weight of polyol (i.e, the combined mass of both the first polyol and the second polyol from the additive composition), which will be hereinafter abbreviated as “php.” Preferably, the additive composition is added to provide a concentration of zeolite composite of about 0.01 php or more, about 0.05 php or more, about 0.1 php or more, about 0.15 php or more, or about 0.2 php or more. The additive composition preferably is added to provide a concentration of zeolite composite of about 1 php or less, about 0.9 php or less, about 0.8 php or less, about 0.7 php or less, or about 0.6 php or less. Thus, in a series of preferred embodiments, the additive composition preferably is added to provide a concentration of zeolite composite of about 0.01 php to about 1 php (e.g., about 0.01 php to about 0.9 php, about 0.01 php to about 0.8 php, about 0.01 php to about 0.7 php, or about 0.01 php to about 0.6 php), about 0.05 php to about 1 php (e.g., about 0.05 php to about 0.9 php, about 0.05 php to about 0.8 php, about 0.05 php to about 0.7 php, or about 0.05 php to about 0.6 php), about 0.1 php to about 1 php (e.g., about 0.1 php to about 0.9 php, about 0.1 php to about 0.8 php, about 0.1 php to about 0.7 php, or about 0.1 php to about 0.6 php), about 0.15 php to about 1 php (e.g., about 0.15 php to about 0.9 php, about 0.15 php to about 0.8 php, about 0.15 php to about 0.7 php, or about 0.15 php to about 0.6 php), or about 0.2 php to about 1 php (e.g., about 0.2 php to about 0.9 php, about 0.2 php to about 0.8 php, about 0.2 php to about 0.7 php, or about 0.2 php to about 0.6 php).

In addition to the first polyol, isocyanate compound, and additive composition, the method can employ an appropriate catalyst to catalyze the reaction between the polyol and the isocyanate compound. Suitable catalysts include amine catalysts (e.g., tertiary amine catalysts), Lewis acid catalysts, and mixtures thereof. Amine catalysts suitable for use in the method include, but are not limited to, triethylenediamine, dimethylcyclohexylamine, dimethylethanolamine, bis-(2-dimethylaminoethyl)ether, and mixtures thereof. Lewis acid catalysts suitable for use in the method include, but are not limited to, alkyl tin carboxylates, oxides, and mercaptides, such as dibutyltin dilaurate, stannous octoate, methyl tin mercaptide, and mixtures thereof.

The reaction mixture of the method can comprise other components in addition to the first polyol, isocyanate compound, additive composition and, if present, catalyst. As noted above, the reaction mixture can further comprise a blowing agent so that the method produces a polyurethane foam. Suitable blowing agents for use in the method include, but are not limited to, water, pentane, 1,1,1,2-tetrafluoroethane, 1,1,1,3,3-pentafluoropropane, 1,1-dichloro-1-fluoroethane, and mixtures thereof. Preferably, the blowing agent is water. The reaction mixture can further comprise one or more surfactants, which can help to emulsify the liquid components, regulate cell size of a foam, and stabilize the cell structure of a foam to prevent collapse and sub-surface voids. Suitable surfactants include, but are not limited to, polydimethylsiloxane-polyoxyalkylene block copolymers, silicone oils, and alcohol ethoxylates (e.g., nonylphenol ethoxylates), and mixtures thereof. The reaction mixture can further comprise chain extenders, cross-linkers, and mixtures thereof. Suitable chain extenders include, but are not limited to, relatively low molar mass (e.g., typically 200 g/mol or less) diols, such as ethylene glycol, diethylene glycol, ethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, ethanolamine, diethanolamine, methyldiethanolamine, and phenyldiethanolamine. Suitable cross-linkers include, but are not limited to, relatively low molar mass (e.g., typically 200 g/mol or less) polyols having three or more hydroxyl groups, such as glycerol, trimethylolpropane, 1,2,6-hexanetriol, triethanolamine, pentaerythritol, and N,N,N′,N′-tetrakis(2-hydroxypropyl)ethylenediamine.

The polyurethane polymer (e.g., polyurethane foam) produced by the method can be used in any suitable application or end use. Preferably, the polyurethane foam is flexible, making it suitable for use as cushioning in, for example, mattresses, furniture, and vehicle seating. The foams produced by the inventive method are believed to be particularly suitable for use as cushioning in vehicle seating (e.g., automotive seating), where the reduction in volatile organic compounds emitted by the foam will be particularly advantageous given the relatively large volume of the vehicle's interior that is occupied by such cushioning.

The following examples further illustrate the subject matter described above but, of course, should not be construed as in any way limiting the scope thereof.

### Example 1

This example demonstrates the production of several zeolite composites suitable for use in making additive compositions according to the invention.

The zeolite composites were made by the following general procedure. First, the indicated amount (by weight) of the nitrogen-containing compound was added to ten (10) parts by weight of water and mixed until the nitrogen-containing compound has completely dissolved. Second, ten (10) parts by weight of zeolite were added to the solution of the nitrogen-containing compound and mixed for approximately ten (10) minutes. Lastly, the resulting zeolite dispersion was placed in an oven maintained at a temperature of approximately 120° C. for approximately 18 hours or until the moisture content of the resulting zeolite composite was less than 2% (whichever occurred last). All of the zeolite composites in this example were made using HSZ-385 HUA zeolite (from Tosoh USA, Inc.). The HSZ-385 HUA zeolite is an H⁺ cation zeolite reported to have a BET specific surface area of 600 m²/g and a mean particle size of 2-3 μm.

The zeolite composite designated “Sample 1A” was made using two (2) parts by weight of aminoguanidine in the procedure described above. The zeolite composite designated “Sample 1B” was made using four (4) parts by weight of aminoguanidine in the procedure described above. The zeolite composite designated “Sample 1C” was made using three (3) parts by weight of metformin in the procedure described above. The zeolite composite designated “Sample 1 D” was made using 3 parts by weight of adipoguanamine in the procedure described above. The resulting zeolite composites were used in making polyurethane foams as described below in Example 2.

### Example 2

This example demonstrates the reduction in volatile organic compound emissions that result from utilizing an additive composition containing a zeolite composite according to the invention.

Polyurethane foams were made using the general formulation provided in Table 1 below in a batch size based on 200 grams of polyol. Each foam was cured for five minutes in an oven maintained at a temperature of approximately 360° F. (182° C.) and then removed from the oven and allowed to cool to room temperature. Each cooled foam was then sealed inside aluminum foil to capture all volatile components until the emission test could be performed.

TABLE 1

| Component | Commercial Source | Amount (parts) |
|---|---|---|
| Ether polyol | Arcol 3040 (Covestro) | 100.0 |
| Water | | 2.0 |
| Toluene diisocyanate | Mondur TD 80 (Covestro) | 30.9 |
| Silicone surfactant | Niax L-620 (Momentive) | 0.65 |
| Amine catalyst | Niax A-1 (Momentive) | 0.1 |
| Amine catalyst | Dabco 33LV (Evonik) | 0.35 |
| Stannous octoate | Dabco T-9 (Evonik) | 0.05 |
| Zeolite Composite | — | As indicated in Table 2 |

Once the foams were produced, emissions testing was performed by cutting a sample measuring 1.5 inches in diameter and 1.0 inches in height from each foam. This cylinder was placed in a microchamber and allowed to equilibrate for 20 minutes at 65° C. prior to sampling the effluent. Nitrogen humidified to 50% RH was flushed through the chamber at 50 mL/min. Effluent analytes were trapped with Tenax® TA adsorbent resin and analyzed with a gas chromatography/mass spectrometry instrument. Identifiable emissions were quantified as toluene equivalents. The “% Reduction in VOC” reported in Table 2 below was calculated by comparing the total VOC measured for the subject foam to the total VOC measured for the control foam.

TABLE 2

| | Control | | | | |
|---|---|---|---|---|---|
| | Foam | Foam 2A | Foam 2B | Foam 2C | Foam 2D |
| Zeolite | — | Sample 1A | Sample 1B | Sample 1C | Sample 1D |
| Composite | | | | | |
| Zeolite Amount | — | 0.4 | 0.4 | 0.4 | 0.4 |
| (php) | | | | | |
| Total VOC | 9357.2 | 6662.6 | 4257.5 | 6184.7 | 7225.9 |
| (μg/m²hr) | | | | | |
| % Reduction in | — | 28.8% | 54.5% | 33.9% | 22.8% |
| VOC | | | | | |

The data in Table 2 show that foams made with a zeolite composite according to the invention all exhibited much lower VOC emissions than the control foam. For example, the VOC emissions for Foam 2B were less than half of the VOC emissions for the control foam, a reduction which was accomplished by adding only 0.4 php of zeolite composite Sample 1B.

### Example 3

This example demonstrates the production of zeolite composites and additive compositions according to the invention.

A first zeolite composite was made following the general procedure described in Example 1 using 3 parts by weight of aminoguanidine and 10 parts by weight of HSZ-385 HUA zeolite. After drying, the resulting zeolite composite was dispersed in Carpol PGP-400 polyol at a 25% (by weight) solids level. The resulting additive composition will be referred to as “Sample 3A.”

A second zeolite composite was made following the general procedure described in Example 1 using 3 parts by weight of aminoguanidine and 10 parts by weight of HSZ-980 HOA zeolite (from Tosoh USA, Inc.). The HSZ-980 HOA zeolite is an H⁺ cation zeolite reported to have a BET specific surface area of 500 g/m² and a mean particle size of 2.5 μm. After drying, the resulting zeolite composite was dispersed in Arcol F-3222 polyol at a 35% (by weight) solids level. The resulting additive composition will be referred to as “Sample 3B.”

### Example 4

This example demonstrates the reduction in volatile organic compound emissions that result from utilizing an additive composition containing a zeolite composite according to the invention.

Polyurethane foams were made using the general formulation provided in Table 3 below in a batch size based on 100 grams of polyol. Each foam was cured for five minutes in an oven maintained at a temperature of approximately 360° F. (182° C.) and then removed from the oven and allowed to cool to room temperature. Each cooled foam was then sealed inside aluminum foil to capture all volatile components until the emission test could be performed.

TABLE 3

| Component | Commercial Source | Amount (parts) |
|---|---|---|
| Ether polyol | Arcol 3040 (Covestro) | 100.0 |
| Water | | 4.56 |
| Toluene diisocyanate | Mondur TD 80 (Covestro) | 59.8 |
| Silicone surfactant | Niax L-620 (Momentive) | 1.0 |
| Amine catalyst | Dabco 33LV (Evonik) | 0.15 |
| Stannous octoate | Dabco T-9 (Evonik) | 0.15 |
| Zeolite Composite | — | As indicated in Table 4 |

Once the foams were produced, emissions testing was performed by cutting a sample measuring 1.5 inches in diameter and 1.0 inches in height from each foam. This cylinder was placed in a microchamber and allowed to equilibrate for 20 minutes at 65° C. prior to sampling the effluent. Nitrogen humidified to 50% RH was flushed through the chamber at 50 mL/min. Effluent analytes were trapped with Tenax® TA adsorbent resin and analyzed with a gas chromatography/mass spectrometry instrument. Triethylenediamine catalyst (TEDA) emissions, which contribute to foam odor, were quantified as toluene equivalents. (The Dabco 33LV amine catalyst is a triethylenediamine catalyst.) The amount of triethylenediamine catalyst emissions detected are reported in Table 4 below.

TABLE 4

| | Control Foam | Foam 4A | Foam 4B |
|---|---|---|---|
| Zeolite Composite | — | Sample 3A | Sample 3B |
| Additive | — | 1.6 | 1.14 |
| Composition | | | |
| Amount (php) | | | |
| Zeolite Composite | — | ~0.4 | ~0.4 |
| Amount (php) | | | |
| Total TEDA | 1,087.7 | None detected | None detected |
| (μg/m²hr) | | | |

As can be seen from the data in Table 4, the foams made with an additive composition according to the invention all exhibited no detectable amine catalyst (TEDA) emissions in the test conditions employed. By way of contrast, the control foam exhibited amine catalyst (TEDA) emissions of 1,087.7 μg/m² hr. Based on these results, it is believed that foams made with the inventive additive compositions will exhibit dramatically reduced VOC emissions and amine odor as compared to foams made without the additive composition.

### Example 5

This example demonstrates the reduction in volatile organic compound emissions that result from utilizing an additive composition containing a zeolite composite according to the invention. The example further demonstrates how the zeolite composite leads to greater VOC reduction as compared to the separate addition of the zeolite and nitrogen-containing compound.

A zeolite composite was made following the general procedure described in Example 1 using 3 parts by weight aminoguanidine and 10 parts of HSZ-385HUA zeolite. The resulting zeolite composite will hereafter be referred to as “Sample 5A.”

Polyurethane foams were made using the general formulation provided in Table 5 below in a batch size based on 200 grams of polyol. Foam 5A was produced by separately adding (i.e., not in a composite form as described above) the HSZ-385HUA zeolite and the aminoguanidine to the reaction mixture during foam production. Each foam was cured for five minutes in an oven maintained at a temperature of approximately 360° F. (182° C.) and then removed from the oven and allowed to cool to room temperature. Each cooled foam was then sealed inside aluminum foil to capture all volatile components until the emission test could be performed.

TABLE 5

| Component | Commercial Source | Amount (parts) |
|---|---|---|
| Ether polyol | Arcol 3040 (Covestro) | 100.0 |
| Water | | 2.0 |
| Toluene diisocyanate | Mondur TD 80 (Covestro) | 30.9 |
| Silicone surfactant | Niax L-620 (Momentive) | 0.65 |
| Amine catalyst | Dabco 33LV (Evonik) | 0.55 |
| Stannous octoate | Dabco T-9 (Evonik) | 0.1 |
| Zeolite Composite/ | — | As indicated in Table 6 |
| Zeolite and Nitrogen- | | |
| containing compound | | |

Once the foams were produced, emissions testing was performed by cutting a sample measuring 1.5 inches in diameter and 1.0 inches in height from each foam. This cylinder was placed in a microchamber and allowed to equilibrate for 20 minutes at 65° C. prior to sampling the effluent. Nitrogen humidified to 50% RH was flushed through the chamber at 50 mL/min. Effluent analytes were trapped with Tenax® TA adsorbent resin and analyzed with a gas chromatography/mass spectrometry instrument. Identifiable emissions, such as triethylenediamine catalyst (TEDA) emissions, were quantified as toluene equivalents. The amount of VOC and TEDA emissions detected are reported in Table 6 below. The “% Reduction” values reported in Table 6 below were calculated by comparing the emissions measured for the subject foam to the emissions measured for the control foam.

TABLE 6

| | Control Foam | Foam 5A | Foam 5B |
|---|---|---|---|
| Zeolite Composite | — | — | Sample 3B |
| Zeolite Composite | — | — | 0.4 |
| Amount (php) | | | |
| Zeolite Amount | | 0.3 | — |
| (php) | | | |
| Aminoguanidine | | 0.1 | — |
| (php) | | | |
| Total VOC | 31,762 | 29,182 | 13,761 |
| (μg/m²hr) | | | |
| % Reduction in | — | 8.1% | 56.7% |
| Total VOC | | | |
| Total TEDA | 29,113 | 25,753 | 10,719 |
| (μg/m²hr) | | | |
| % Reduction in | — | 11.5% | 63.2% |
| TEDA | | | |

The data in Table 6 show that separate addition of the zeolite and nitrogen-containing compound during foam production (Foam 5A) only yielded an 8.1% reduction in total VOC emissions and an 11.5% reduction in TEDA emissions. By way of contrast, when the same amount of zeolite and nitrogen-containing compound were added in the composite form described herein, the resulting foam (Foam 5B) exhibited a 56.7% reduction in total VOC emissions and a 63.2% reduction in TEDA emissions. This dramatic reduction in emissions is surprising given that the only difference between the two foams is the form (i.e., composite vs. non-composite) in which the zeolite and nitrogen-containing compound were added to the foam. These data are believed to show that foams made with the inventive additive compositions will exhibit dramatically reduced VOC emissions and amine emissions/odor as compared to foams made without the additive composition.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. An additive composition comprising:
(a) a polyol;
(b) a zeolite composite dispersed in the polyol, the zeolite composite comprising:
(i) a zeolite substrate, said zeolite substrate having a surface and a plurality of pores in said surface; and
(ii) a nitrogen-containing compound adsorbed within at least a portion of the pores in the surface of the zeolite substrate, the nitrogen-containing compound comprising (A) a first functional group comprising a carbon atom doubly bonded to a nitrogen atom and (B) a second functional group comprising a hydrogen atom covalently bonded to a nitrogen atom.

2. The additive composition of claim 1, wherein the polyol has a molar mass of about 400 g/mol or more.

3. The additive composition of claim 1, wherein the polyol is a polyether polyol.

4. The additive composition of claim 1, wherein the zeolite composite is present in the additive composition in an amount of about 5 wt. % to about 30 wt. %, based on the combined weight of polyol and zeolite composite present in the additive composition.

5. The additive composition of claim 1, wherein the zeolite substrate is an H⁺ cation zeolite.

6. The additive composition of claim 1, wherein the nitrogen-containing compound is present in the zeolite composite in an amount of about 15 wt. % to about 50 wt. %, based on the combined weight of zeolite substrate and nitrogen-containing compound.

7. The additive composition of claim 1, wherein the nitrogen-containing compound comprises at least two second functional groups comprising a hydrogen atom covalently bonded to a nitrogen atom.

8. The additive composition of claim 1, wherein the nitrogen-containing compound is selected from the group consisting of guanidine compounds, aminoguanidine compounds, biguanide compounds, guanamine compounds, and mixtures thereof.

9. A method for making a polyurethane polymer, the method comprising the steps of:
(a) providing a first polyol;
(b) providing an isocyanate compound comprising two or more isocyanate groups;
(c) providing an additive composition comprising:
(i) a second polyol; and
(ii) a zeolite composite dispersed in the second polyol, the zeolite composite comprising:
(A) a zeolite substrate, said zeolite substrate having a surface and a plurality of pores in said surface; and
(B) a nitrogen-containing compound adsorbed within at least a portion of the pores in the surface of the zeolite substrate, the nitrogen-containing compound comprising (1) a first functional group comprising a carbon atom doubly bonded to a nitrogen atom and (2) a second functional group comprising a hydrogen atom covalently bonded to a nitrogen atom
(d) combining the first polyol, the isocyanate compound, and the additive composition to produce a reaction mixture; and
(e) reacting the isocyanate compound with the first and second polyols to produce a polyurethane polymer, wherein the zeolite composite is dispersed in the polyurethane polymer.

10. The method of claim 9, wherein the second polyol has a molar mass of about 400 g/mol or more.

11. The method of claim 9, wherein the second polyol is a polyether polyol.

12. The method of claim 9, wherein the zeolite composite is present in the additive composition in an amount of about 5 wt. % to about 30 wt. %, based on the combined weight of polyol and zeolite composite present in the additive composition.

13. The method of claim 9, wherein the zeolite substrate is an H⁺ cation zeolite.

14. The method of claim 9, wherein the nitrogen-containing compound is present in the zeolite composite in an amount of about 15 wt. % to about 50 wt. %, based on the combined weight of zeolite substrate and nitrogen-containing compound.

15. The method of claim 9, wherein the nitrogen-containing compound comprises at least two second functional groups comprising a hydrogen atom covalently bonded to a nitrogen atom.

16. The method of claim 9, wherein the nitrogen-containing compound is selected from the group consisting of aminoguanidine compounds, biguanide compounds, guanamine compounds, and mixtures thereof.

17. The method of claim 9, wherein the reaction mixture comprises about 0.1 or more parts by weight zeolite composite per one hundred parts by weight polyol.
